(19) United States
(12) Patent Application Publication
(10) Pub. No.: US 2013/0185668 A1
(43) Pub. Date: Jul. 18, 2013

(54) VIRTUAL KEYBOARD ARRANGEMENT

(71) Applicants: Scott Martin, Levy, SC (US); Kristin Medin, Rincon, GA (US)

(72) Inventors: Scott Martin, Levy, SC (US); Kristin Medin, Rincon, GA (US)

(73) Assignee: GULFSTREAM AEROSPACE CORPORATION, Savannah, GA (US)

(21) Appl. No.: 13/351,113

(22) Filed: Jan. 16, 2012

(51) Int. Cl. G06F 3/048; G06F 3/041

(52) U.S. Cl. 715/773

(57) ABSTRACT

A display assembly includes display having a bottom edge. An input device is integrated with the display for receiving input from a user. A plurality of icons are arranged as a row and displayed on the display. Each of the icons is selectable by the user. The row of icons is displayed non-parallel to the bottom edge of the display.

### BACKGROUND OF THE INVENTION

1. Field of the Invention

The invention relates generally to a virtual keyboard and specifically to a keyboard displayed on a touchscreen display for a vehicle.

2. Description of the Related Art

Virtual keyboards, i.e., keyboards displayed on a touchscreen display for data entry, are well known in the art and have been used in numerous vehicular applications. Unfortunately, these virtual keyboards can be difficult to operate as the size of the “keys” is typically small. Furthermore, the arrangement and positioning of these “keys” may not be optimal, especially when the touchscreen display is to a side of the user.

Accordingly, it is desirable to provide a virtual keyboard on a touchscreen display that is easier to operate. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

A display assembly includes display having a bottom edge. An input device is integrated with the display for receiving input from a user. A plurality of icons are arranged as a row and displayed on the display. Each of the icons is selectable by the user. The row of icons is displayed non-parallel to the bottom edge of the display.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top view of a cockpit of an aircraft showing a plurality of display assemblies disposed to the sides of operators of the aircraft;

FIG. 2 is a partial side view of the cockpit of the aircraft showing one of the display assemblies disposed to the side of one of the operators of the aircraft;

FIG. 3 is front view of a first embodiment of the display assembly of FIG. 2 with a plurality of icons arranged into angled rows;

FIG. 4 is a front view of a second embodiment of the display assembly;

FIG. 5 is a front view of a third embodiment of the display assembly;

FIG. 6 is a front view of a fourth embodiment of the display assembly;

FIG. 7 is a front view of a fifth embodiment of the display assembly; and

FIG. 8 is a front view of the display assembly with the plurality of icons arranged into horizontal rows.

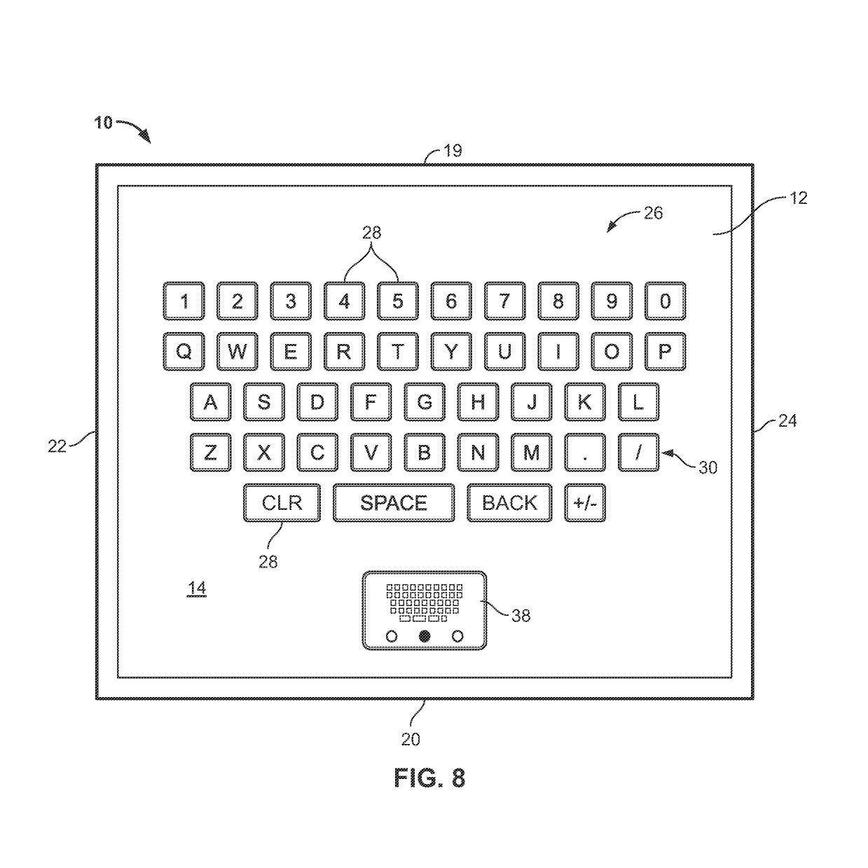

### DETAILED DESCRIPTION OF THE INVENTION

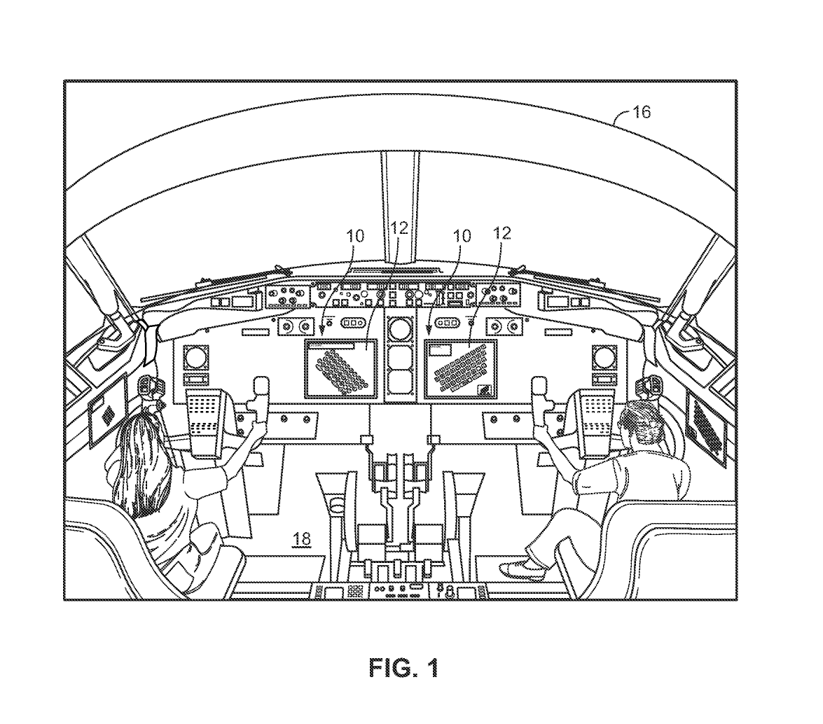

Referring to the Figures, a display assembly 10 is shown and described herein. The display assembly 10 may be configured for a vehicle 16 as shown in FIG. 1.

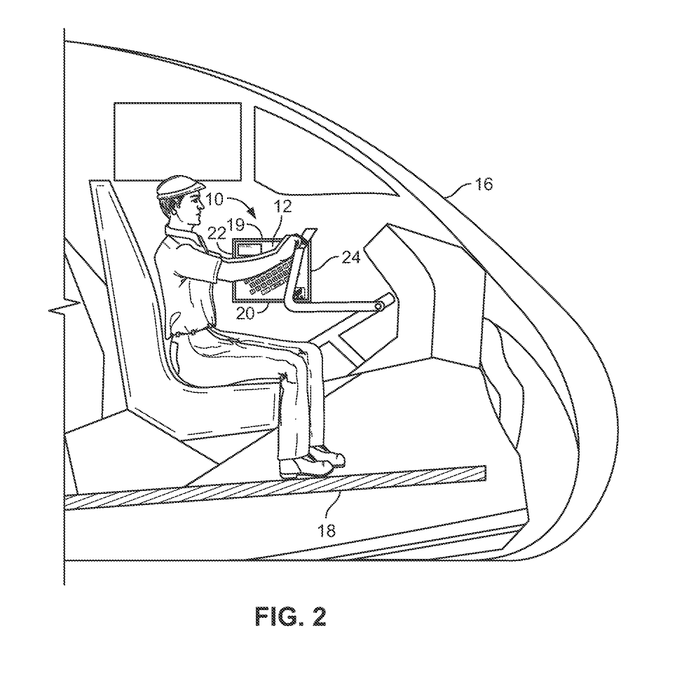

Referring to FIG. 2, the display assembly 10 is preferably a “touchscreen display”. Accordingly, and as realized by those skilled in the art, the display assembly 10 includes a display 12 and an input device 14. The display 12 displays images, data, and/or information to a user, as is well known to those skilled in the art. The input device 14 is integrated with said display for receiving input from the user. More specifically, the input device 14 of the illustrated embodiment can detect the presence and location of a touch on the display 12.

The display 12 may be implemented with any suitable display technology, including, but not limited to, a liquid crystal display (LCD), a cathode ray tube (CRT), and a plasma screen. The input device 14 may employ any suitable touchscreen technology, including, but not limited to, capacitive, resistive, surface acoustic wave, infrared, and optical imaging.

Referring again to FIG. 1, the display assembly 10 in the illustrated embodiment is disposed in a vehicle 16. More specifically, the display assembly 10 is disposed in a cockpit (not numbered) of an aircraft (not separately numbered) within the viewing area and reach of the user. Even more specifically, the display assembly 10 may be located to the side of a pilot of the aircraft. Of course, the display assembly 10 described herein may be located at any position in the vehicle or in non-vehicle applications.

The vehicle 16 includes a base plane 18. The base plane 18 is generally parallel to the ground when the vehicle 16, e.g., the aircraft, is located on the ground. In the illustrated embodiment, the base plane 18 may be embodied as a floor of the vehicle 16. The base plane 18 in the illustrated embodiment is also generally parallel to a seat (not numbered) of a chair (not numbered) in the cockpit of the aircraft.

Referring again to FIG. 2, the display 12 of the illustrated embodiments has a generally rectangular shape as is typically standard. As such, the display 12 includes a top edge 19, a bottom edge 20, and a pair of side edges 22, 24. The top and bottom edges 19, 20 are parallel with one another. The side edges 22, 24 are perpendicular with the top and bottom edges 19, 20. The side edges 22, 24 also extend between, i.e., separate, the top and bottom edges 19, 20. Of course, the display 12 may define other shapes, e.g., circular, triangular, etc., as is realized by those skilled in the art.

In the illustrated embodiments, the display assembly 10 is disposed in the vehicle 16 such that the top and bottom edges 19, 20 of the display 12 are generally parallel to the base plane 18 of the vehicle 16, as can be seen with reference again to FIG. 1. As such, the side edges 22, 24 are generally perpendicular to the base plane 18. In another embodiment (not shown), the side edges 22, 24 may be generally parallel to the base plane 18 while the top and bottom edges 19, 20 are perpendicular to the base plane 18. In yet another embodiment (also not shown), the display assembly 10 may be disposed in the vehicle 16 such that none of the edges 19, 20, 22, 24 are parallel or perpendicular to the base plane 18

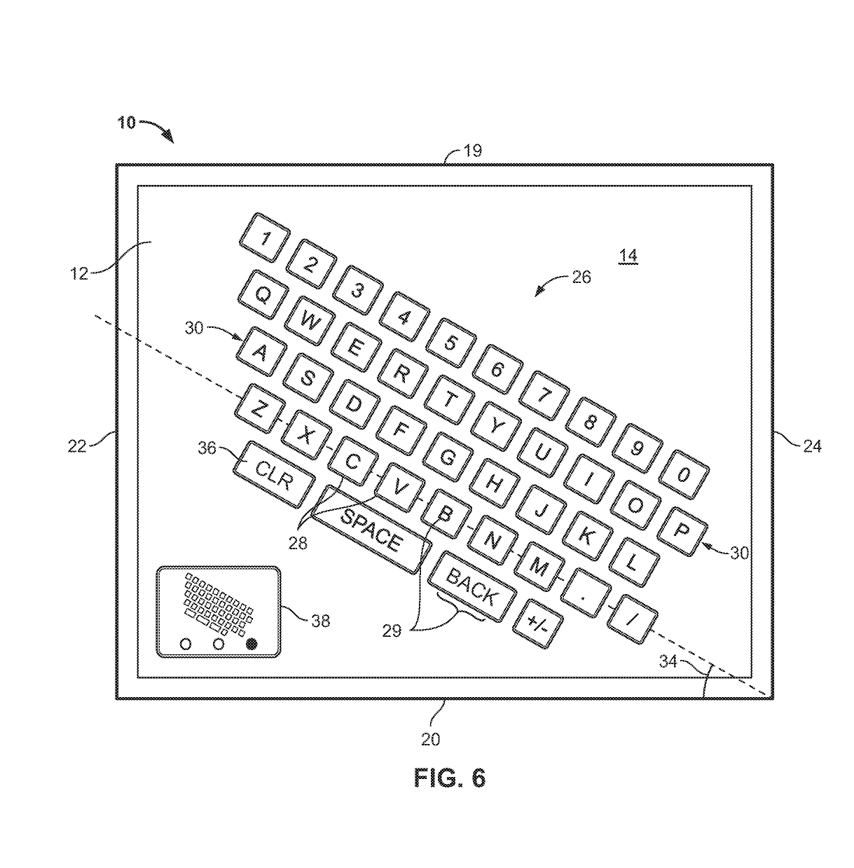

Referring to any of the FIG. 2-6, the display 12 displays a keyboard 26 (or keypad) allowing input by the user. More specifically, the keyboard 26 is made up of a plurality of icons 28 displayed on the display 12. In a first through a fourth embodiment, as shown in FIGS. 2-5, the keyboard 26 has a standard English-language “QWERTY” arrangement. In a fifth embodiment, as shown in FIG. 6, the keyboard 26 has a number pad arrangement like a traditional telephone. However, the icons 28 may be arranged in any suitable arrangement to allow input by the user for any application and/or language.

In the illustrated embodiments, the icons 28 are arranged in a plurality of rows 30 on the display 12. Of course, in alterative embodiments, the icons 28 may be arranged in a single row 30. Each row 30 refers to an imaginary line (not separately numbered) which is disposed through at least two of the icons 28 or adjacent to at least two of the icons 28.

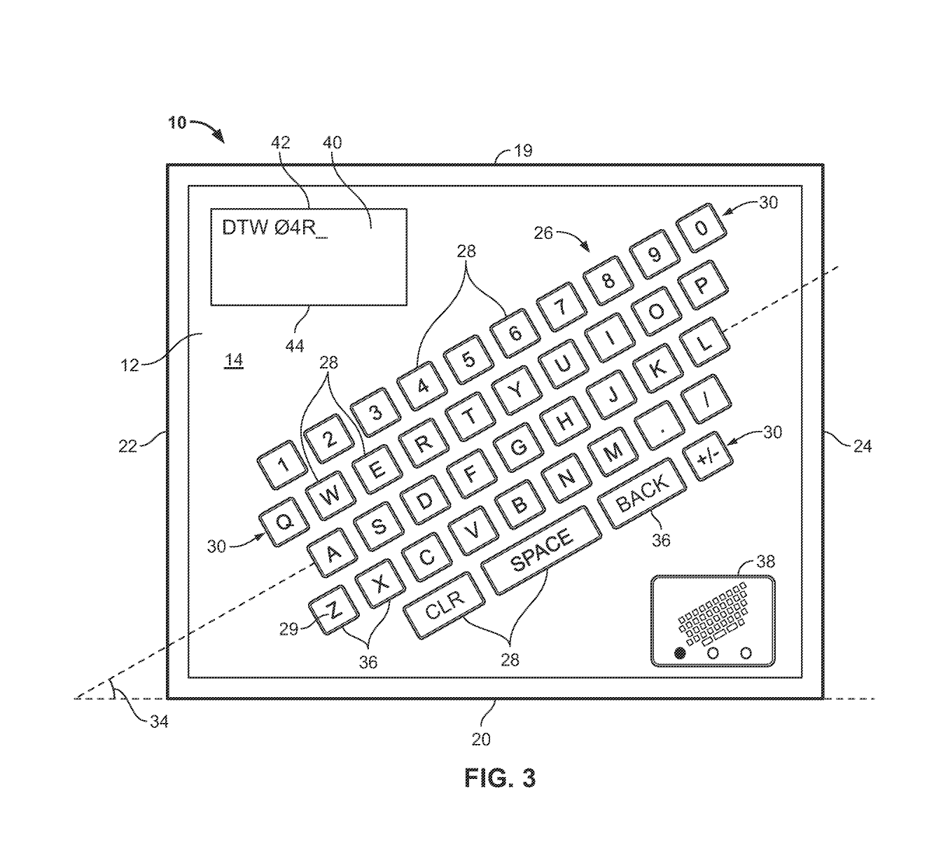

Each icon 28 may represent a letter, a number, a symbol, and/or a space. Each icon 28 may alternatively represent a specialized command, such as an enter command, a backspace, or a delete, as will be appreciated by those skilled in the art. In the first, third, and fourth embodiments, as shown in FIGS. 2, 4, and 5, each icon 28 has a generally rectangular or square shape. However, in other embodiments, the icons 28 may define alternative shapes, including, but not limited to, circles and ovals. For instance, in the second embodiment, as shown in FIG. 3, the icons 28 are circular and/or ovular shaped. Furthermore, in each of the illustrated embodiments, each icon 28 encloses one or more characters 29 representing the letter, number, symbol, space, or specialized command. However, in other embodiments (not shown), one or more of the icon 28 may themselves represent the letter, number, symbol, space, or command. Said another way, an icon 28 may be shaped like the representative character or characters 29.

Each of the icons 28 is selectable by the user. That is, by utilizing the input device 14, the user can enter information, data, and/or commands. This information, data, and/or commands may be passed along to a processor (not shown) in communication with the display assembly 10.

Referring again to FIG. 2, at least one row 30 of icons 28 is angled with respect to the bottom edge 20 of the display 12. That is, the at least one row 30 is not parallel to the bottom edge 20. As such, in the illustrated embodiment, where the bottom edge 20 of the display 12 is generally parallel to the base plane 18, the at least one row 30 of icons 28 is also angled with respect to the base plane 18, i.e., non-parallel to the base plane 18.

In the illustrated embodiments, the at least one row 30 is disposed at an angle 34 between 10 and 80 degrees with respect to the bottom edge 20 of the display 12. Of course, the angle 34 between 10 and 80 degrees can alternately be represented as angles 34 between 100 and 170 degrees, between 190 and 260 degrees, 280 and 350 degrees, and/or −10 and −80 degrees. Even more specifically, the angle 34 is about 30 degrees with respect to the bottom edge 20 of the display 12. Of course, the angle 34 of 30 degrees can alternately be represented as 150 degrees, 210 degrees, 330 degrees, and/or −30 degrees.

In the illustrated embodiments, the icons 28 form a plurality of rows 30 and each of the rows are angled with respect to the bottom edge. More specifically, in the illustrated embodiments, each of the rows 30 is displayed at an angle 34 between 10 and 80 degrees with respect to the bottom edge 20. Preferably, each of the rows 30 is displayed at the same angle 34 of about 30 degrees, such that each of the rows 30 is parallel to one another.

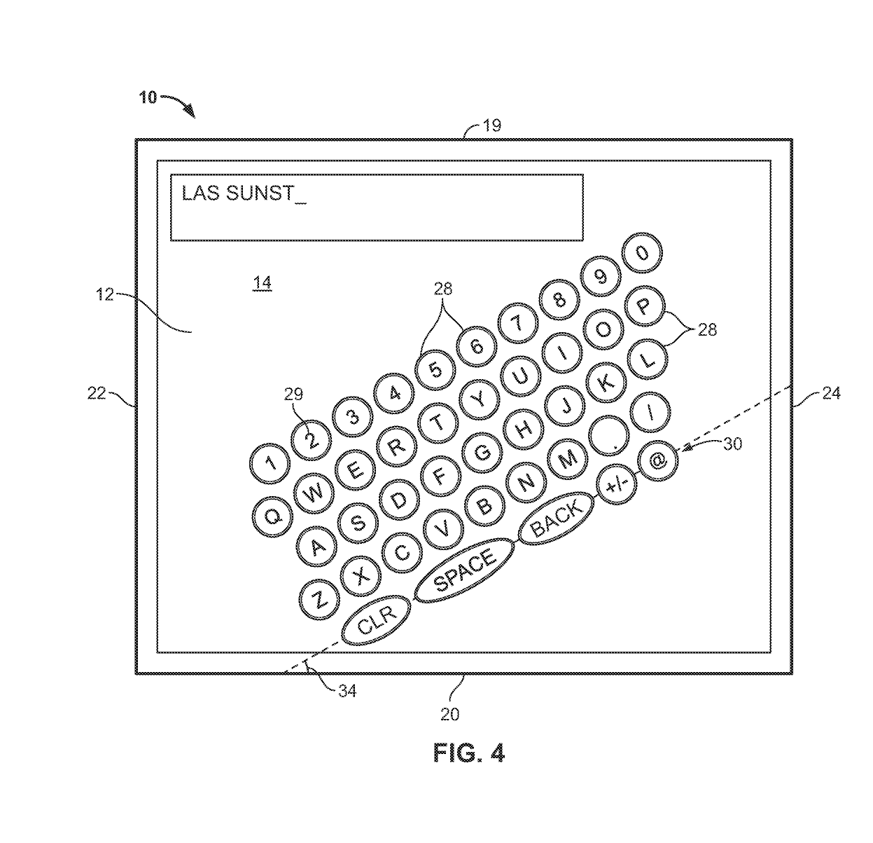

In the first, third, and fourth embodiments, as shown in FIGS. 2, 4, and 5, each icon 28 has a rectangular shape. The bottom edge 36 of each icon 28 is also angled with respect to the bottom edge 20 of the display 12. The angle (not separately numbered) of the bottom edge 36 to the bottom edge 20 is also between 10 and 80 degrees and preferably about 30 degrees. As such, each icon 28 need not necessarily be arranged into a row with other icons 28 in order to be angled with respect to the bottom edge 20 of the display 12. For example, referring to the third embodiment represented in FIG. 4, a single icon 28 representing a “space” has a bottom edge 36 angled with respect to the bottom edge 20 of the display 12.

In each of the illustrated embodiments, the characters 29 disposed in each of the icons 28 is also angled with respect to the bottom edge 20 of the display 12. The angle (not separately numbered) of each character 29 to the bottom edge 20 is also between 10 and 80 degrees and preferably about 30 degrees.

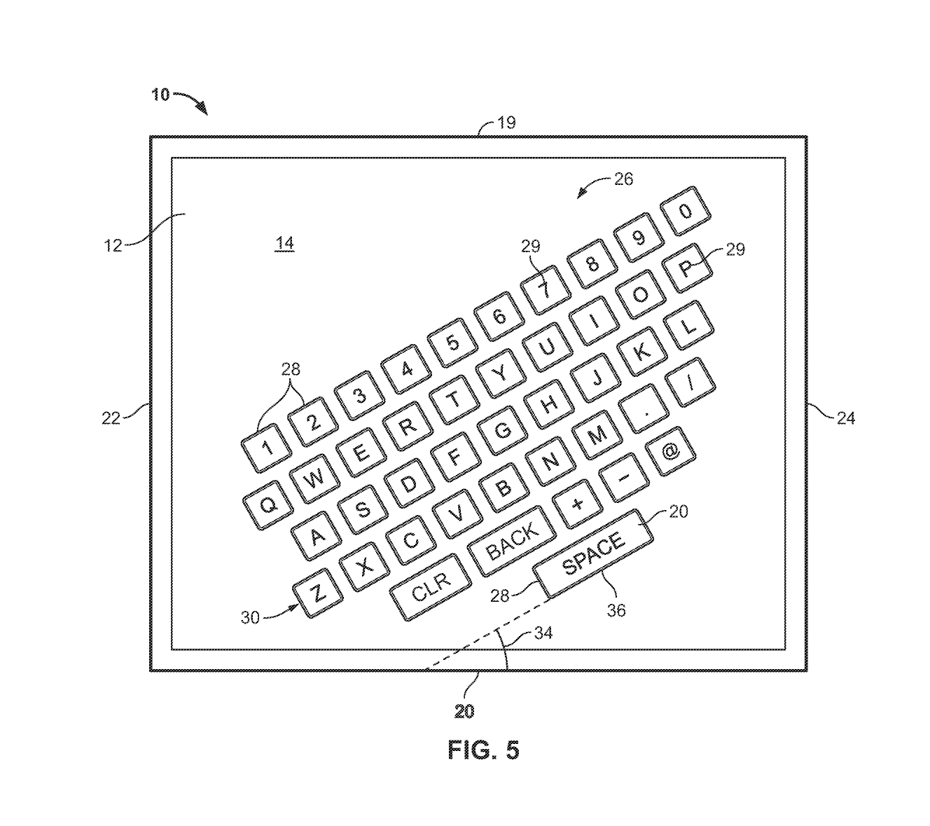

The angle 34 of the at least one row 30 to the bottom edge 20 of the display 12 may be adjusted based on the location of the display assembly 10 in the vehicle 16, physical dimensions of the user, physical dimensions of the vehicle 16, preference of the user, and/or other rationale that will be realized by those skilled in the art. In the first through third embodiments, shown in FIGS. 2-4, the rows 30 extend between a lower left-hand corner and a upper right-hand corner of the display 12. This configuration is often, but not always, ideal when the display assembly 10 is positioned to the left of the user, for left-handed operation, as shown in FIG. 1. Differently, in the fourth embodiment, as shown in FIG. 5, the rows 30 extend between an upper left-hand corner and a lower right-hand corner of the display 12. This configuration is often, but not always, ideal when the display assembly 10 is positioned to the fight of the user, for right-handed operation.

Angling of the row 30 or rows 30 of icons 28, the bottom edge 36 of the icons 28, and/or the characters 29, allows for easier entry of data by the user, especially when the display assembly 10 is disposed to a side of the user. Furthermore, by angling the row 30 or rows 30 of icons 28, more icons 28 can be fit into the display 12 versus a conventional horizontal keyboard display. As such, larger icons 28, which are easier to operate, may be displayed on the display 12. Alternatively, the size of the display 12 may be reduced without reducing the size of the icons 28 displayed.

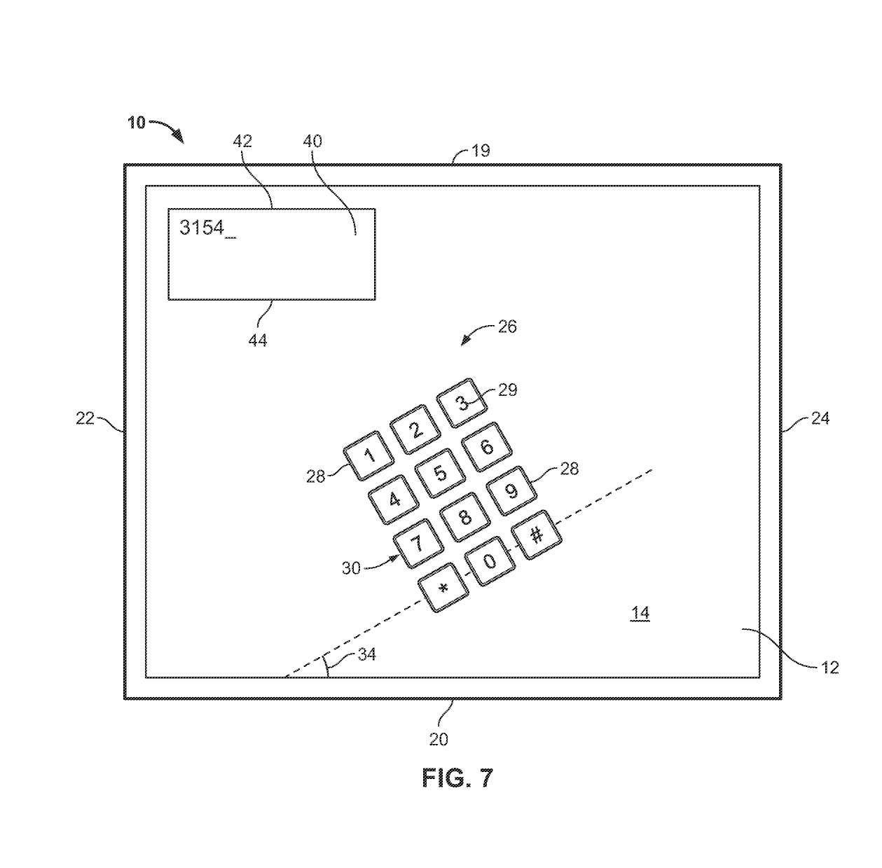

Referring again to FIG. 2, the display 12 may include a selector icon 38 for changing the angle 34 of display of the at least one row 30. By touching the selector icon 38, the user may change the angle 34 between the configuration shown in FIG. 2, to the configuration shown in FIG. 5, and a configuration shown in FIG. 7. In FIG. 7, the at least one row 30 is generally parallel to the bottom 20 of the display 12. More specifically, the rows 30 of the icons 26 are disposed in a standard horizontal configuration. In alterative embodiments (not shown), the angle 34 of the at least one row 30 may be more finely adjusted by the user. For example, the angle 34 of the at least one row 30 may be adjusted in any increment for the comfort or desire of the user.

Referring once again to FIG. 2, the display 12 may further include an entered data window 40 for viewing the data and/or information entered using the input device 14. The entered data window 40 of the illustrated embodiments is rectangular in shape with a top edge 42 and a bottom edge 44. The top and bottom edges 42, 44 of the entered data window 40 are generally parallel to the top and bottom edges 19, 20 of the display 12. Accordingly, the at least one row 30 of icons 28 is also angled with respect to the entered data window 40. While the angling of the at least one row 30 of icons 28 may be desirable for ease and comfort of entering data, the preferred viewing of characters is generally parallel to the bottom edge 20 of the display 12 and the base plane 18 of the vehicle 16. However, in other embodiments, the top and bottom edges 42, 44 of the entered data window 40 may be non-parallel to the bottom edge 20 of the display 12.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A display assembly comprising:
a display including a bottom edge;
an input device integrated with said display for receiving input from a user; and
a plurality of icons arranged as a row of icons and displayed on said display;
wherein
each of said icons is selectable by the user; and wherein
said row of icons is displayed non-parallel to said bottom edge of said display.

2. A display assembly as set forth in claim 1 wherein said row of icons is displayed at an angle between 10 and 80 degrees with respect to said bottom edge of said display.

3. A display assembly as set forth in claim 1 wherein said row of icons is displayed at an angle of about 30 degrees with respect to said bottom edge of said display.

4. A display assembly as set forth in claim 1 wherein said row of icons is further defined as a plurality of rows of icons and wherein at least one of said rows of icons is displayed at an angle between 10 and 80 degrees with respect to said bottom edge.

5. A display assembly as set forth in claim 4 wherein each of said rows of icons is displayed at the same angle.

6. A display assembly as set forth in claim 1 further comprising a selector icon for changing the angle of display of said row of icons.

7. A display assembly as set forth in claim 1 further comprising an entered data window displayed on said display for viewing data entered using the input device.

8. A display assembly as set forth in claim 7 wherein said entered data window includes a bottom edge generally parallel to said bottom edge of said display.

9. A display assembly as set forth in claim 1 wherein said display includes a top edge parallel to said bottom edge and a pair of side edges perpendicular to and extending between said top and bottom edges.

10. A display assembly for a vehicle having a base plane, said display assembly comprising:
a display;
an input device integrated with said display for receiving input from a user; and
a plurality of icons arranged as a row of icons and displayed on said display;
wherein
each of said icons selectable by the user; and wherein
said row of icons is displayed non-parallel to the base plane of the vehicle.

11. A display assembly as set forth in claim 10 wherein said row of icons is displayed at an angle between 10 and 80 degrees with respect to the base plane of the vehicle.

12. A display assembly as set forth in claim 10 wherein said row of icons is displayed at an angle of about 30 degrees with respect to the base plane of the vehicle.

13. A display assembly as set forth in claim 10 wherein said row of icons is further defined as a plurality of rows of icons and wherein at least one of said rows of icons is displayed at an angle between 10 and 80 degrees with respect to the base plane.

14. A display assembly as set forth in claim 13 wherein each of said rows of icons is displayed at the same angle.

15. A method of providing a keyboard on a touchscreen display having a bottom edge, said method comprising the steps of:
arranging a plurality of icons into a row; and
displaying the row of icons non-parallel to the bottom edge of the display, wherein at least one of the icons is selectable by the user.

16. A method as set forth in claim 15 wherein said step of display the row of icons is further defined as displaying the row of icons at an angle between 10 and 80 degrees with respect to the bottom edge of the display, wherein at least one of the icons is selectable by the user.

17. A method as set forth in claim 15 wherein said step of display the row of icons is further defined as displaying the row of icons at an angle of about 30 degrees with respect to the bottom edge of the display, wherein at least one of the icons is selectable by the user.

18. A method as set forth in claim 15 wherein the row of icons is further defined as a plurality of rows of icons and said step of displaying the row of icons is further defined as displaying each row of icons at the same angle non-parallel to the bottom edge of the display.

19. A method as set forth in claim 15 further comprising the step of displaying an entered data window on the display for viewing data entered using the selectable icons.

20. A method as set forth in claim 19 wherein the entered data window includes a bottom edge and wherein said step of displaying the entered data window is further defined as displaying the entered data window such that the bottom edge of the entered data window is generally parallel to the bottom edge of the display.
